(19) United States
(12) Patent Application Publication
(10) Pub. No.: US 2017/0045238 A1
(43) Pub. Date: Feb. 16, 2017

(54) METHOD FOR OPERATING A HEAT PUMP WATER HEATER APPLIANCE

(71) Applicant: General Electric Company, Schenectady, NY (US)

(72) Inventors: Eric Xavier Meusburger, Mount Prospect, IL (US); Ryan Ge-chel Kung, Louisville, KY (US)

(21) Appl. No.: 14/824,468

(22) Filed: Aug. 12, 2015

(51) Int. Cl. F24D 19/10; F24D 17/00; F24D 15/04; G01K 13/00; F24D 12/02

(52) U.S. Cl. CPC F24D 19/1039; G01K 13/00; F24D 12/02; F24D 15/04; F24D 17/0036; F24D 19/1072

(57) ABSTRACT

A method for operating a heat pump water heater appliance positioned with a building is provided. The method includes receiving a measurement of ambient temperature about the building via a network and also getting a measurement of ambient temperature about the heat pump water heater appliance within the building. The method further includes heating water within the heat pump water heater appliance with only a sealed system of the heat pump water heater appliance or with only a secondary heating element of the heat pump water heater appliance based upon the measurement of ambient temperature about the building and the measurement of ambient temperature about the heat pump water heater appliance within the building.

### FIELD OF THE INVENTION

The present subject matter relates generally to heat pump water heater appliances and methods for operating the same.

### BACKGROUND OF THE INVENTION

Water heater appliances generally operate to heat water within the water heater appliance's tank to a set temperature. The set temperature is generally selected such that heated water within the tank is at least hot enough for showering, washing hands, etc. Heat pump water heaters are gaining broader acceptance as a more economic and ecologically-friendly alternative to electric and gas water heaters. Heat pump water heaters include a sealed system for heating water to the set temperature. Sealed systems generally heat water more efficiently than electric heating elements and gas burners.

In addition to the sealed system, certain heat pump water heaters also include secondary heaters. The secondary heaters generally have a higher power output relative to the sealed system but also generally heat water less efficiently. Selecting whether to heat water within the heat pump water heater with the sealed system or the secondary heaters can be difficult. For certain heat pump water heaters, a user selects an operating mode, and the sealed system and/or secondary heaters operate to heat water in response to the selected operating mode. However, the user's selection may be infrequently changed to operate the heat pump water heater efficiently.

Accordingly, a method for operating a heat pump water heater appliance with features for determining whether to heat water with a sealed system or a secondary heater of the heat pump water heater would be useful.

### BRIEF DESCRIPTION OF THE INVENTION

The present subject matter provides a method for operating a heat pump water heater appliance positioned with a building. The method includes receiving a measurement of ambient temperature about the building via a network and also getting a measurement of ambient temperature about the heat pump water heater appliance within the building. The method further includes heating water within the heat pump water heater appliance with only a sealed system of the heat pump water heater appliance or with only a secondary heating element of the heat pump water heater appliance based upon the measurement of ambient temperature about the building and the measurement of ambient temperature about the heat pump water heater appliance within the building. Additional aspects and advantages of the invention will be set forth in part in the following description, or may be apparent from the description, or may be learned through practice of the invention.

In a first exemplary embodiment, a method for operating a heat pump water heater appliance positioned with a building is provided. The method includes connecting the heat pump water heater appliance to a network, receiving a measurement of ambient temperature about the building via the network, getting a measurement of ambient temperature about the heat pump water heater appliance within the building, and heating water within the heat pump water heater appliance with only a sealed system of the heat pump water heater appliance if either the measurement of ambient temperature about the building is greater than a first predetermined temperature or the measurement of ambient temperature about the heat pump water heater appliance within the building is greater than a second predetermined temperature.

In a second exemplary embodiment, a method for operating a heat pump water heater appliance positioned with a building is provided. The method includes connecting the heat pump water heater appliance to a network, receiving a measurement of ambient temperature about the building via the network, getting a measurement of ambient temperature about the heat pump water heater appliance within the building, and heating water within the heat pump water heater appliance with only a secondary heating element of the heat pump water heater appliance if either the measurement of ambient temperature about the building is less than a first predetermined temperature or the measurement of ambient temperature about the heat pump water heater appliance within the building is less than a second predetermined temperature. The secondary heating element of the heat pump water heater appliance includes an electric resistance heating element or a gas burner.

In a third exemplary embodiment, a method for operating a heat pump water heater appliance positioned with a building is provided. The method includes connecting the heat pump water heater appliance to a network and receiving a status of an HVAC thermostat within the building via the network. The status of the HVAC thermostat includes a heating mode or a cooling mode. The method also includes heating water within the heat pump water heater appliance with a sealed system of the heat pump water heater appliance if the status of the HVAC thermostat is the cooling mode or heating water within the heat pump water heater appliance with only a secondary heating element of the heat pump water heater appliance if the status of the HVAC thermostat is the heating mode. The secondary heating element of the heat pump water heater appliance includes an electric resistance heating element or a gas burner.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of the exemplary water heater appliance of FIG. 1.

FIG. 3 illustrates a method for operating a water heater appliance according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

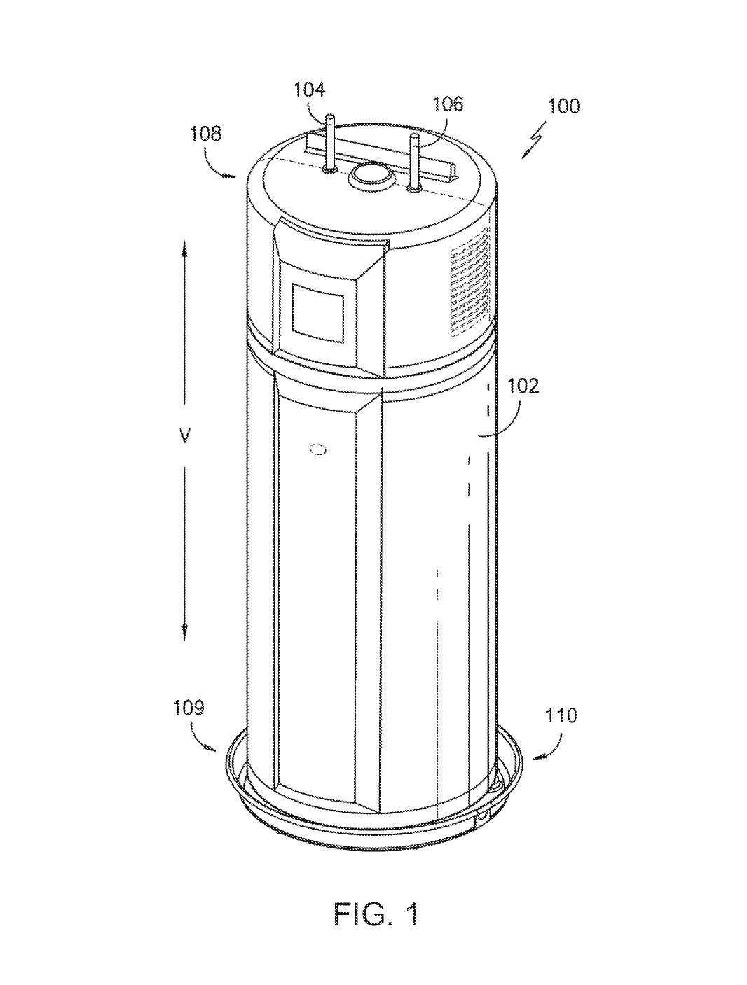

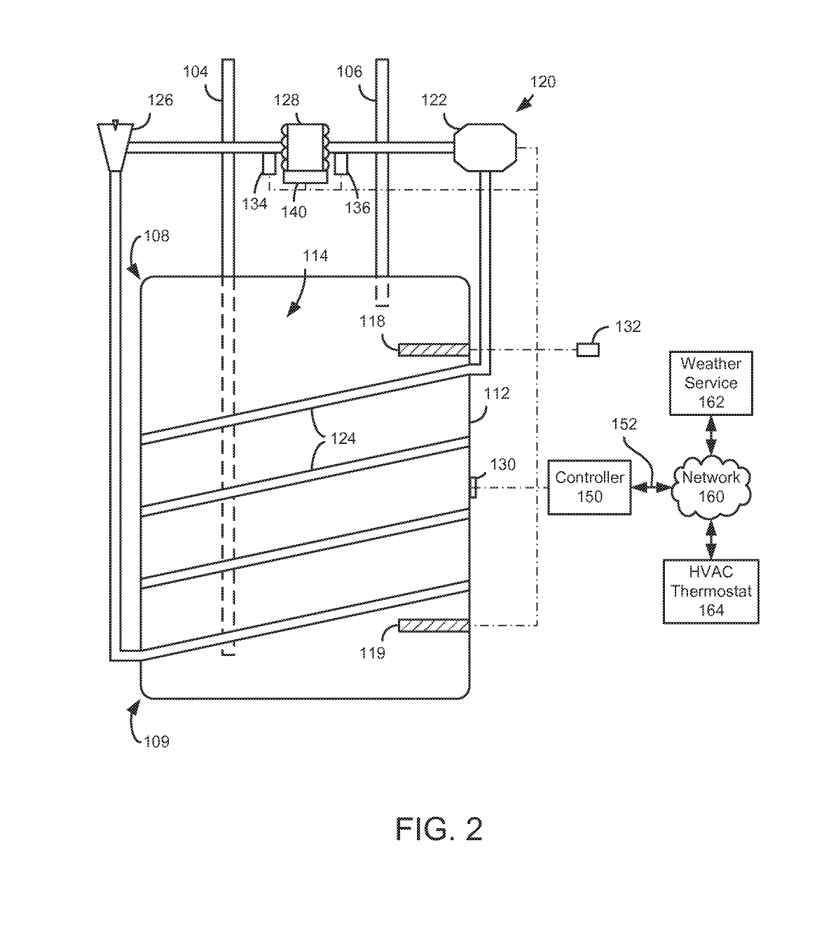

FIG. 1 provides a perspective view of a water heater appliance 100 according to an exemplary embodiment of the present subject matter. FIG. 2 provides a schematic view of certain components of water heater appliance 100. As may be seen in FIGS. 1 and 2, water heater appliance 100 includes a casing 102 and a tank 112 mounted within casing 102. Tank 112 defines an interior volume 114 for heating water therein. Water heater appliance 100 may include similar components, be constructed in a similar manner to and/or operate in the manner described in U.S. Pat. No. 8,422,870 of Nelson et al., which is hereby incorporated by reference in its entirety.

Water heater appliance 100 also includes a cold water conduit 104 and a hot water conduit 106 that are both in fluid communication with tank 112 within casing 102. As an example, cold water from a water source, e.g., a municipal water supply or a well, enters water heater appliance 100 through cold water conduit 104. From cold water conduit 104, such cold water enters interior volume 114 of tank 112 wherein the water is heated to generate heated water. Such heated water exits water heater appliance 100 at hot water conduit 106 and, e.g., is supplied to a bath, shower, sink, or any other suitable feature.

As may be seen in FIG. 1, water heater appliance 100 extends between a top portion 108 and a bottom portion 109 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100.

A drain pan 110 is positioned at bottom portion 109 of water heater appliance 100 such that water heater appliance 100 sits on drain pan 110. Drain pan 110 sits beneath water heater appliance 100 along the vertical direction V, e.g., to collect water that leaks from water heater appliance 100 or water that condenses on an evaporator 128 of water heater appliance 100. It should be understood that water heater appliance 100 is provided by way of example only and that the present subject matter may be used with any suitable water heater appliance.

Turning now to FIG. 2, water heater appliance 100 includes an upper heating element 118, a lower heating element 119 and a sealed system 120 for heating water within interior volume 114 of tank 112. Thus, water heater appliance 100 is commonly referred to as a “heat pump water heater appliance.” Upper and lower heating elements 118 and 119 can be any suitable heating elements. For example, upper heating element 118 and/or lower heating element 119 may be an electric resistance element, a microwave element, an induction element, or any other suitable heating element or combination thereof. Lower heating element 119 may also be a gas burner, and water heater appliance 100 need not include upper heating element 118 when lower heating element 119 is a gas burner.

Sealed system 120 includes a compressor 122, a condenser 124, a throttling device 126 and an evaporator 128. Condenser 124 is thermally coupled or assembled in a heat exchange relationship with tank 112 in order to heat water within interior volume 114 of tank 112 during operation of sealed system 120. In particular, condenser 124 may be a conduit coiled around and mounted to tank 112. During operation of sealed system 120, refrigerant exits evaporator 128 as a fluid in the form of a superheated vapor and/or high quality vapor mixture. Upon exiting evaporator 128, the refrigerant enters compressor 122 wherein the pressure and temperature of the refrigerant are increased such that the refrigerant becomes a superheated vapor. The superheated vapor from compressor 122 enters condenser 124 wherein it transfers energy to the water within tank 112 and condenses into a saturated liquid and/or high quality liquid vapor mixture. This high quality/saturated liquid vapor mixture exits condenser 124 and travels through throttling device 126 that is configured for regulating a flow rate of refrigerant therethrough. Upon exiting throttling device 126, the pressure and temperature of the refrigerant drop at which time the refrigerant enters evaporator 128 and the cycle repeats itself In certain exemplary embodiments, throttling device 126 may be an electronic expansion valve (EEV).

A fan or air handler 140 may assist with heat transfer between air about water heater appliance 100, e.g., within casing 102, and refrigerant within evaporator 128. Air handler 140 may be positioned within casing 102 on or adjacent evaporator 128. Thus, when activated, air handler 140 may direct a flow of air towards or across evaporator 128, and the flow of air from air handler 140 may assist with heating refrigerant within evaporator 128. Air handler 140 may be any suitable type of air handler, such as an axial or centrifugal fan.

Water heater appliance 100 also includes a tank temperature sensor 130. Tank temperature sensor 130 is configured for measuring a temperature of water within interior volume 114 of tank 112. Tank temperature sensor 130 can be positioned at any suitable location within or on water heater appliance 100. For example, tank temperature sensor 130 may be positioned within interior volume 114 of tank 112 or may be mounted to tank 112 outside of interior volume 114 of tank 112. When mounted to tank 112 outside of interior volume 114 of tank 112, tank temperature sensor 130 can be configured for indirectly measuring the temperature of water within interior volume 114 of tank 112. For example, tank temperature sensor 130 can measure the temperature of tank 112 and correlate the temperature of tank 112 to the temperature of water within interior volume 114 of tank 112. Tank temperature sensor 130 may also be positioned at or adjacent top portion 108 of water heater appliance 100, e.g., at or adjacent an inlet of hot water conduit 106.

Tank temperature sensor 130 can be any suitable temperature sensor. For example, tank temperature sensor 130 may be a thermocouple or a thermistor. As may be seen in FIG. 2, tank temperature sensor 130 may be the only temperature sensor positioned at or on tank 112 that is configured for measuring the temperature of water within interior volume 114 of tank 112 in certain exemplary embodiments. In alternative exemplary embodiments, additional temperature sensors may be positioned at or on tank 112 to assist tank temperature sensor 130 with measuring the temperature of water within interior volume 114 of tank 112, e.g., at other locations within interior volume 114 of tank 112.

Water heater appliance 100 also includes an ambient temperature sensor 132, an evaporator inlet temperature sensor 134 and an evaporator outlet temperature sensor 136. Ambient temperature sensor 132 is configured for measuring a temperature of air about water heater appliance 100. Ambient temperature sensor 132 can be positioned at any suitable location within or on water heater appliance 100. For example, ambient temperature sensor 132 may be mounted to casing 102, e.g., at or adjacent top portion 108 of water heater appliance 100. Ambient temperature sensor 132 can be any suitable temperature sensor. For example, ambient temperature sensor 132 may be a thermocouple or a thermistor.

Evaporator inlet temperature sensor 134 is configured for measuring a temperature of refrigerant at or adjacent inlet of evaporator 128. Thus, evaporator inlet temperature sensor 134 may be positioned at or adjacent inlet of evaporator 128, as shown in FIG. 2. For example, evaporator inlet temperature sensor 134 may be mounted to tubing that directs refrigerant into evaporator 128, e.g., at or adjacent inlet of evaporator 128. When mounted to tubing, evaporator inlet temperature sensor 134 can be configured for indirectly measuring the temperature of refrigerant at inlet of evaporator 128. For example, evaporator inlet temperature sensor 134 can measure the temperature of the tubing and correlate the temperature of the tubing to the temperature of refrigerant at inlet of evaporator 128. Evaporator inlet temperature sensor 134 can be any suitable temperature sensor. For example, evaporator inlet temperature sensor 134 may be a thermocouple or a thermistor.

Evaporator outlet temperature sensor 136 is configured for measuring a temperature of refrigerant at or adjacent outlet of evaporator 128. Thus, evaporator outlet temperature sensor 136 may be positioned at or adjacent outlet of evaporator 128, as shown in FIG. 2. For example, evaporator outlet temperature sensor 136 may be mounted to tubing that directs refrigerant out of evaporator 128, e.g., at or adjacent outlet of evaporator 128. When mounted to tubing, evaporator outlet temperature sensor 136 can be configured for indirectly measuring the temperature of refrigerant at outlet of evaporator 128. For example, evaporator outlet temperature sensor 136 can measure the temperature of the tubing and correlate the temperature of the tubing to the temperature of refrigerant at outlet of evaporator 128. Evaporator outlet temperature sensor 136 can be any suitable temperature sensor. For example, evaporator outlet temperature sensor 136 may be a thermocouple or a thermistor.

Water heater appliance 100 further includes a controller 150 that is configured for regulating operation of water heater appliance 100. Controller 150 is in, e.g., operative, communication with upper heating element 118, lower heating element 119, compressor 122, tank temperature sensor 130, ambient temperature sensor 132, evaporator inlet temperature sensor 134, evaporator outlet temperature sensor 136, and air handler 140. Thus, controller 150 may selectively activate upper and lower heating elements 118 and 119 and/or compressor 122 in order to heat water within interior volume 114 of tank 112, e.g., in response to signals from tank temperature sensor 130, ambient temperature sensor 132, evaporator inlet temperature sensor 134 and/or evaporator outlet temperature sensor 136.

It should be understood that controller 150 may be integrated within water heater appliance 100, in certain exemplary embodiments. However, in alternative exemplary embodiments, controller 150 may be separate from other components of water heater appliance 100 and be positioned outside of casing 102. Thus, controller 150 may be positioned remotely relative to casing 102, e.g., within a building housing water heater appliance 100. In such exemplary embodiments, controller 150 may wirelessly communicate with other components of water heater appliance 100.

Controller 150 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 150 may include a clock and/or calendar within the memory of controller 150. The clock may be any suitable type of time keeping mechanism. For example, the clock may be a real time clock integrated within controller 150. The clock may be configured to keep the current date and time. Controller 150 may receive the current date and time from a remote time service, such as time.gov, or a user may manually enter the current date and time in order to set the clock of controller 150. The calendar of controller 150 may include seasonal weather categories, such as winter months and summer months.

Controller 150 may operate upper heating element 118, lower heating element 119 and/or compressor 122 in order to heat water within interior volume 114 of tank 112. As an example, a user may select or establish a set temperature, tₛ, for water within interior volume 114 of tank 112, or the set temperature tₛ for water within interior volume 114 of tank 112 may be a default value. Based upon the set temperature tₛ for water within interior volume 114 of tank 112, controller 150 may selectively activate upper heating element 118, lower heating element 119 and/or compressor 122 in order to heat water within interior volume 114 of tank 112 to the set temperature tₛ for water within interior volume 114 of tank 112. The set temperature tₛ for water within interior volume 114 of tank 112 may be any suitable temperature. For example, the set temperature tₛ for water within interior volume 114 of tank 112 may be between about one hundred degrees Fahrenheit and about one hundred and eighty-degrees Fahrenheit. As used herein with regards to temperature approximations, the term “about” means within ten degrees of the stated temperature.

Controller 150 also includes a network interface (not shown). The controller 150 of water heater appliance 100 may include any suitable components for interfacing with one more networks, such as a network 160. For example, the network interface may include transmitters, receivers, ports, controllers, antennas, or other suitable components for interfacing with network 160. The network interface may establish communication with network 160 via a connection 152. Connection 152 may be any suitable medium, e.g., wired or wireless.

Network 160 may be any type of communications network, such as a local area network (e.g. intranet), wide area network (e.g. Internet), or some combination thereof In general, communication between controller 150 and network 160 may be carried via associated network interfaces using any type of connection, using a variety of communication protocols (e.g. TCP/IP, HTTP), encodings or formats (e.g. HTML, XML), and/or protection schemes (e.g. VPN, secure HTTP, SSL). In particular, network 160 may be a wireless local area network (WLAN) configured to conform to IEEE 802.11.

Water heater appliance 100 also includes features for assisting with regulating a temperature of air about water heater appliance 100 and/or with complementing heating or cooling of air within a building housing water heater appliance 100, e.g., by an HVAC system, such as an air conditioner or heater. As an example, controller 150 of water heater appliance 100 may receive temperature measurements or an HVAC status, and controller 150 may heat water within tank 112 with either sealed system 120 or upper and lower heating elements 118 and 119 in response to the received temperature measurements or HVAC status, as discussed in greater detail below. By complementing heating or cooling of air within a building housing water heater appliance 100, an efficiency of the HVAC system can be improved.

As may be seen in FIG. 2, controller 150 may receive data or information from various sources via network 160. For example, controller 150 may be in communication with a weather service 162 via network 160. Controller 150 may request and/or receive weather data from weather service 162. The weather data from weather service 162 may include the temperature of exterior ambient air in the area around a building housing water heater appliance 100. For example, the weather data from weather service 162 may include the current temperature for the local area within which the building housing water heater appliance 100 is located. The weather service 162 may be any suitable website or service, such as weather.gov, weatherbug.com, etc.

Controller 150 may receive data other than or in addition to weather data via network 160. For example, controller 150 may receive a status of an HVAC system associated with the building housing water heater appliance 100 from an HVAC thermostat 164 via network 160. As will be understood by those skilled in the art, a user of the HVAC system may select whether the HVAC system operates to heat air or cool air with the HVAC thermostat 164. Thus, e.g., the user may select a “cooling mode” or a “heating mode” at HVAC thermostat 164. In the cooling mode, the HVAC system operates to cool air within the building housing water heater appliance 100. Conversely, the HVAC system operates to heat air within the building housing water heater appliance 100 in the heating mode. Thus, HVAC thermostat 164 may communicate to controller 150 whether the HVAC system is in the heating mode or the cooling mode via network 160.

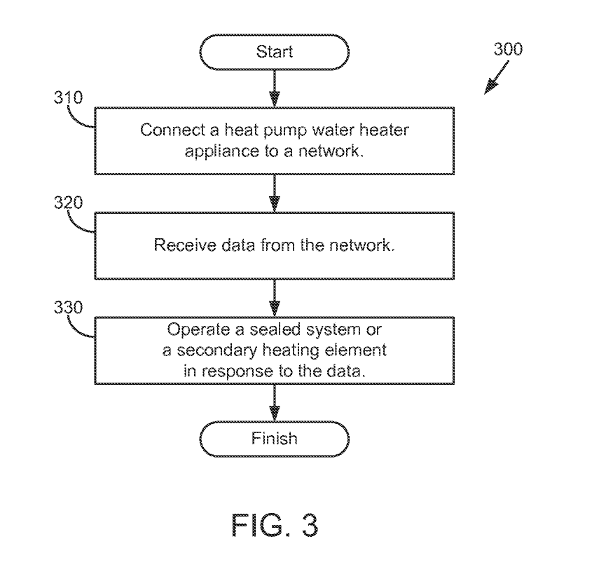

Controller 150 may regulate operation of water heater appliance 100 utilizing information or data from weather service 162 and/or HVAC thermostat 164. In particular, controller 150 may heat water within tank 112 with either sealed system 120 or upper and lower heating elements 118 and 119 in response to temperature measurements from weather service 162 or the HVAC status from HVAC thermostat 164. Such features of water heater appliance 100 are discussed in greater detail below in the context of FIG. 3.

FIG. 3 illustrates a method 300 for operating a water heater appliance according to an exemplary embodiment of the present subject matter. Method 300 may be used to operate any suitable heat pump water heater appliance. For example, method 300 may be used to operate water heater appliance 100. Thus, method 300 is discussed in greater detail below in the context of water heater appliance 100. Controller 150 may be configured or programmed to implement various steps of method 300. Utilizing method 300, controller 150 may heat water within tank 112 in a manner that complements the heating or cooling of air within a building housing water heater appliance 100, as discussed in greater detail below.

At step 310, water heater appliance 100 is connected to network 160. For example, controller 150 of water heater appliance 100 may connect to network 160 with the network interface of controller 150, e.g., in the manner described above. As discussed above, network 160 may be a wireless network, such as a Wi-Fi network.

At step 320, controller 150 receives data from network 160. As an example, controller 150 may receive a measurement of an exterior ambient temperature about the building housing water heater appliance 100, e.g., from weather service 162, via network 160 at step 320. In addition to the measurement of ambient temperature about the building housing water heater appliance 100, controller 150 may also receive or get a measurement of an interior ambient temperature about water heater appliance 100 within the building, e.g., from ambient temperature sensor 132 or from HVAC thermostat 164 via network 160, at step 320. As another example, controller 150 may receive the status of HVAC thermostat 164 via network 160 at step 320.

At step 330, controller 150 operates either sealed system 120 or upper and lower heating elements 118 and 119 based upon or in response to the data from network 160 received at step 320. As an example, controller 150 may activate compressor 122 at step 330 in order to heat water within tank 112 with sealed system 120 if the measurement of ambient temperature about the building housing water heater appliance 100 is greater than a first predetermined temperature and/or if the measurement of ambient temperature about water heater appliance 100 within the building is greater than a second predetermined temperature. Thus, controller 150 may activate only compressor 122 at step 330 and maintain upper and lower heating elements 118 and 119 in a deactivated state if the measurement of ambient temperature about the building housing water heater appliance 100 is greater than the first predetermined temperature and/or if the measurement of ambient temperature about water heater appliance 100 within the building is greater than the second predetermined temperature. Conversely, controller 150 may activate upper heating element 118 and/or lower heating element 119 at step 330 in order to heat water within tank 112 if the measurement of ambient temperature about the building housing water heater appliance 100 is less than the first predetermined temperature and/or if the measurement of ambient temperature about water heater appliance 100 within the building is less than the second predetermined temperature. Thus, controller 150 may activate only upper and lower heating elements 118 and 119 at step 330 and maintain compressor 122 in a deactivated state if the measurement of ambient temperature about the building housing water heater appliance 100 is less than the first predetermined temperature and/or if the measurement of ambient temperature about water heater appliance 100 within the building is less than the second predetermined temperature.

Operating sealed system 120 to heat water within tank 112 at step 330 may assist operation of the HVAC system. In particular, the sealed system 120 may utilize heat within the building housing water heater appliance 100 to supplement cooling by HVAC system when the ambient temperature about the building housing water heater appliance 100 is greater than the first predetermined temperature and/or when the ambient temperature about water heater appliance 100 within the building is greater than the second predetermined temperature. Conversely, operating upper heating element 118 and/or lower heating element 119 to heat water within tank 112 and deactivating sealed system 120 may prevent sealed system 120 from pumping heat from the ambient atmosphere about water heater appliance 100 and cooling air about water heater appliance 100.

The first and second predetermined temperatures may be any suitable temperatures. For example, the first predetermined temperature measurement may be about seventy-five degrees Fahrenheit, about eighty degrees Fahrenheit, etc., and the second predetermined temperature measurement may be about sixty-five degrees Fahrenheit, about seventy degrees Fahrenheit, etc. As used herein the term “about” means within five degrees of the stated temperature when used in the context of temperatures. The first and second predetermined temperatures may be selected by a user of water heater appliance 100 or be a default value provided by a manufacturer of water heater appliance 100.

As another example, controller 150 may activate compressor 122 in order to heat water within tank 112 at step 330 if the status of HVAC thermostat 164 is the cooling mode. Thus, controller 150 may activate only compressor 122 at step 330 and maintain upper and lower heating elements 118 and 119 in a deactivated state if the status of HVAC thermostat 164 is the cooling mode. Conversely, controller 150 may activate upper heating element 118 and/or lower heating element 119 at step 330 in order to heat water within tank 112 if the status of HVAC thermostat 164 is the heating mode. Thus, controller 150 may activate only upper and lower heating elements 118 and 119 at step 330 and maintain compressor 122 in a deactivated state if the status of HVAC thermostat 164 is the heating mode.

It should be understood that the above described activation of compressor 122 or upper and lower heating elements 118 and 119 in response to the status of HVAC thermostat 164 assumes that water heater appliance 100 is operating under low demand, e.g., such heated water is drawn from water heater appliance 100 at a relatively low rate and sealed system 120 may provide sufficient energy to maintain water within interior volume 114 of tank 112 at the set temperature tₛ. During operation of water heater appliance 100 under high demand, heater water is drawn from water heater appliance 100 at a relatively high rate, and sealed system 120 may be unable to sufficiently heat water within tank 112 to maintain water within interior volume 114 of tank 112 at the set temperature L. Thus, water heater appliance 100 may supplement sealed system 120 during high demand periods by activating upper heating element 118 and/or lower heating element 119 despite the status of HVAC thermostat 164 being the cooling mode in order to continue providing heated water at the set temperature tₛ during the high demand periods, in certain exemplary embodiments.

Operating sealed system 120 to heat water within tank 112 at step 330 if the status of HVAC thermostat 164 is the cooling mode may assist operation of the HVAC system. In particular, the sealed system 120 may utilize heat within the building housing water heater appliance 100 to supplement cooling by HVAC system. Operating upper heating element 118 and/or lower heating element 119 to heat water within tank 112 at step 330 if the status of HVAC thermostat 164 is the heating mode may also assist operation of the HVAC system. In particular, deactivating sealed system 120 and may prevent sealed system 120 from pumping heat from the ambient atmosphere about water heater appliance 100 and cooling air about water heater appliance 100.

As another example, controller 150 may activate compressor 122 in order to heat water within tank 112 at step 330 if the calendar within the memory of controller 150 indicates that the current date falls within a summer season. Thus, controller 150 may activate only compressor 122 at step 330 and maintain upper and lower heating elements 118 and 119 in a deactivated state if the current date corresponds to the summer season. Conversely, controller 150 may activate upper heating element 118 and/or lower heating element 119 at step 330 in order to heat water within tank 112 if the calendar within the memory of controller 150 indicates that the current date falls within a winter season. Thus, controller 150 may activate only upper and lower heating elements 118 and 119 at step 330 and maintain compressor 122 in a deactivated state if the current date corresponds to the winter season.

Operating sealed system 120 to heat water within tank 112 at step 330 if the current date corresponds to the summer season may assist operation of the HVAC system. In particular, the sealed system 120 may utilize heat within the building housing water heater appliance 100 to supplement cooling by HVAC system. Operating upper heating element 118 and/or lower heating element 119 to heat water within tank 112 at step 330 if the current date corresponds to the winter season may also assist operation of the HVAC system. In particular, deactivating sealed system 120 and may prevent sealed system 120 from pumping heat from the ambient atmosphere about water heater appliance 100 and cooling air about water heater appliance 100.

As may be seen from the above, method 300 may utilize information about outside temperature, inside temperature, thermostat set temperature, etc. to drive an operation mode and behavior of water heater appliance 100. In such a manner, method 300 operate water heater appliance 100 to supplement and/or complement operation of an HVAC system of the building housing water heater appliance 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a heat pump water heater appliance positioned with a building, comprising:
connecting the heat pump water heater appliance to a network;
receiving a measurement of ambient temperature about the building via the network;
getting a measurement of ambient temperature about the heat pump water heater appliance within the building; and
heating water within the heat pump water heater appliance with only a sealed system of the heat pump water heater appliance if either the measurement of ambient temperature about the building is greater than a first predetermined temperature or the measurement of ambient temperature about the heat pump water heater appliance within the building is greater than a second predetermined temperature.

2. The method of claim 1, wherein said step of connecting comprises connecting the heat pump water heater appliance to wireless network of the building in which the heat pump water heater appliance is located.

3. The method of claim 1, wherein said step of receiving the measurement of ambient temperature about the building via the network comprises receiving the measurement of ambient temperature about the building via the network from a weather service via the network.

4. The method of claim 3, wherein said step of getting the measurement of ambient temperature about the heat pump water heater appliance within the building comprises measuring the ambient temperature about the heat pump water heater appliance within the building with an ambient temperature sensor of the heat pump water heater appliance.

5. The method of claim 3, wherein said step of getting the measurement of ambient temperature about the heat pump water heater appliance within the building comprises receiving the measurement of ambient temperature about the heat pump water heater appliance within the building from an HVAC thermostat within the building via the network.

6. The method of claim 1, wherein a secondary heating element of the heat pump water heater appliance is deactivated during said step of heating, the secondary heating element of the heat pump water heater appliance comprising an electric resistance heating element or a gas burner.

7. The method of claim 1, wherein said step of heating further comprises heating water within the heat pump water heater appliance with only a secondary heating element of the heat pump water heater appliance if either the measurement of ambient temperature about the building is less than the first predetermined temperature or the measurement of ambient temperature about the heat pump water heater appliance within the building is less than the second predetermined temperature, the secondary heating element of the heat pump water heater appliance comprising an electric resistance heating element or a gas burner.

8. A method for operating a heat pump water heater appliance positioned with a building, comprising:
connecting the heat pump water heater appliance to a network;
receiving a measurement of ambient temperature about the building via the network;
getting a measurement of ambient temperature about the heat pump water heater appliance within the building; and
heating water within the heat pump water heater appliance with only a secondary heating element of the heat pump water heater appliance if either the measurement of ambient temperature about the building is less than a first predetermined temperature or the measurement of ambient temperature about the heat pump water heater appliance within the building is less than a second predetermined temperature, the secondary heating element of the heat pump water heater appliance comprising an electric resistance heating element or a gas burner.

9. The method of claim 8, wherein said step of connecting comprises connecting the heat pump water heater appliance to wireless network of the building in which the heat pump water heater appliance is located.

10. The method of claim 8, wherein said step of receiving the measurement of ambient temperature about the building via the network comprises receiving the measurement of ambient temperature about the building via the network from a weather service via the network.

11. The method of claim 10, wherein said step of getting the measurement of ambient temperature about the heat pump water heater appliance within the building comprises measuring the ambient temperature about the heat pump water heater appliance within the building with an ambient temperature sensor of the heat pump water heater appliance.

12. The method of claim 10, wherein said step of getting the measurement of ambient temperature about the heat pump water heater appliance within the building comprises receiving the measurement of ambient temperature about the heat pump water heater appliance within the building from an HVAC thermostat within the building via the network.

13. The method of claim 8, wherein a sealed system of the heat pump water heater appliance is deactivated during said step of heating.

14. The method of claim 8, wherein said step of heating further comprises heating water within the heat pump water heater appliance with only a sealed system of the heat pump water heater appliance if either the measurement of ambient temperature about the building is greater than the first predetermined temperature or the measurement of ambient temperature about the heat pump water heater appliance within the building is greater than the second predetermined temperature.

15. A method for operating a heat pump water heater appliance positioned with a building, comprising:
connecting the heat pump water heater appliance to a network;
receiving a status of an HVAC thermostat within the building via the network, the status of the HVAC thermostat comprising a heating mode or a cooling mode; and
heating water within the heat pump water heater appliance with a sealed system of the heat pump water heater appliance if the status of the HVAC thermostat is the cooling mode or heating water within the heat pump water heater appliance with only a secondary heating element of the heat pump water heater appliance if the status of the HVAC thermostat is the heating mode, the secondary heating element of the heat pump water heater appliance comprising an electric resistance heating element or a gas burner.

16. The method of claim 15, wherein said step of connecting comprises connecting the heat pump water heater appliance to wireless network of the building in which the heat pump water heater appliance is located.

17. The method of claim 15, wherein the sealed system of the heat pump water heater appliance is deactivated if the status of the HVAC thermostat is the heating mode.
